(19) United States
(12) Patent Application Publication
(10) Pub. No.: US 2011/0141257 A1
(43) Pub. Date: Jun. 16, 2011

(54) APPARATUS AND METHOD FOR REGISTERING PLURALITY OF FACIAL IMAGES FOR FACE RECOGNITION

(75) Inventors: Yoon-Choon Hwang, Bupyeong-gu (KR); Sung-Dae Cho, Yongin-si (KR); Byung-Jun Son, Seoul (KR); Tae-Hwa Hong, Seoul (KR); Chung-Hoon Kim, Seongnam-si (KR); Nitin Singhal, Suwon-si (KR)

(73) Assignee: Samsung Electronics Co., Ltd., Suwon-si (KR)

(21) Appl. No.: 12/969,073

(22) Filed: Dec. 15, 2010

(30) Foreign Application Priority Data
Dec. 15, 2009 (KR) 10-2009-0124416

(51) Int. Cl. G06K 9/00; H04N 7/18

(52) U.S. Cl. 348/77; 382/118; 348/E07.085

(57) ABSTRACT

A facial image registration apparatus and method are provided for registering a plurality of facial images to be used for face recognition. A plurality of facial images are detected and sorted from a plurality of captured images input from a camera unit at the request of a user. A face feature value is calculated for each of the facial images. The face feature value is a score that is applied according to face features of each of the facial images. Facial images selected according to the calculated face feature values are registered as target facial images to be used for face recognition. As such, various facial images may be registered at a user's single request, thus improving a face recognition rate.

### PRIORITY

This application claims priority under 35 U.S.C. §119(a) to a Korean Patent Application filed in the Korean Intellectual Property Office on Dec. 15, 2009 and assigned Serial No. 10-2009-0124416, the entire disclosure of which is incorporated herein by reference.

### BACKGROUND OF THE INVENTION

1. Field of the Invention

The present invention relates generally to an apparatus and method for registering a plurality of facial images for face recognition, and more particularly, to a facial image registration apparatus and method for registering a plurality of facial images at a time.

2. Description of the Related Art

Recent implementations in face recognition technology include a real-time preview face recognition function in cameras of portable terminals, snap cameras, and Digital Single-Lens Reflex cameras (DSLRs), as well as the use of a plurality of frames and information thereof to perform a real-time preview face recognition process.

Individual identification or user authentication and identification technology for personal-information protection have become more and more important. For example, pictures or cards, such as an identification card or a driver's license, are used as identification means.

However, carrying those identification means at all times is inconvenient to users. As a result, much research has been conducted on biometric recognition technologies using human body characteristics for personal-information protection and identification with computers. These technologies include fingerprint recognition or iris recognition.

Unlike recognition technologies that requiring a user's special gesture or action, the face recognition technology is less forced and can identify a user in a contactless manner.

The face recognition technology, which is also a core technology of multimedia data base search, has been widely used in various application fields, such as summarization of an image, identification, image search, security, surveillance systems, and the like.

As such, conventional face recognition recognizes a user's face by using facial characteristics of the user.

However, a result of face recognition is sensitive and changes according to a change in an internal environment, such as identity, a race, a facial expression, an accessory, or the like, and a change in an external environment such as a pose, an external lighting, an image process, or the like.

The performance of face recognition improves as more characteristics or images of an individual are used for face recognition. Consequently, in a terminal used in an embedded condition such as a mobile device, storing many facial characteristics puts much computational load on an algorithm for performing face recognition.

### SUMMARY OF THE INVENTION

The present invention has been made to address at least the above problems and/or disadvantages and to provide at least the advantages described below. Accordingly, an aspect of the present invention provides a facial image registration apparatus and method for registering a plurality of facial images at a time to improve a face recognition rate.

According to an aspect of the present invention, a facial image registration apparatus is provided for registering a plurality of facial images for face recognition. The facial image registration apparatus includes a camera unit for capturing and outputting a plurality of images, a face detector for detecting a plurality of facial images from the plurality of captured images, respectively, and a face feature value calculator for calculating a face feature value for each of the plurality of facial images. The face feature value is a score applied according to face features of each of the plurality of facial images. The facial image registration apparatus also includes a controller for detecting and sorting the plurality of facial images at the request of a user through the face detector, calculating face feature values for the plurality of sorted facial images through the face feature value calculator, and registering target facial images to be used for face recognition which are selected according to the calculated face feature values.

According to another aspect of the present invention, a facial image registration method is provided for registering a plurality of facial images to be used for face recognition. A plurality of facial images are detected and sorted from a plurality of images input from a camera unit at the request of a user. A face feature value is calculated for each of the plurality of facial images. The face feature value is a score that is applied according to face features of each of the plurality of facial images. Target facial images, which are selected according to the calculated face feature values, are registered to be used for face recognition.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating a facial image registration apparatus, according to an embodiment of the present invention;

FIG. 2 is a flowchart illustrating a process for registering a plurality of target facial images to be used for face recognition and performing face recognition by using the registered target facial images, according to an embodiment of the present invention; and

FIG. 3 is a flowchart illustrating a facial image registration method for registering a plurality of target facial images to be used for face recognition, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

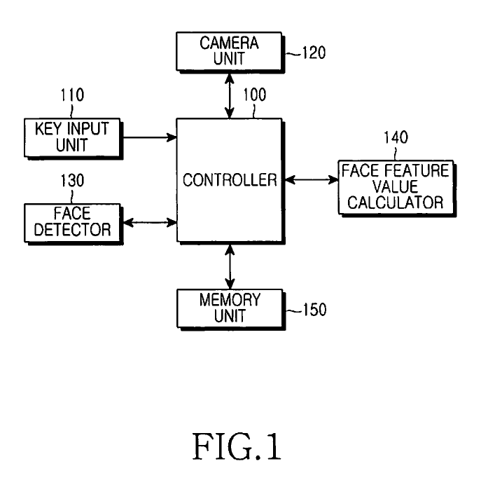

FIG. 1 is a block diagram illustrating a facial image registration apparatus, according to an embodiment of the present invention.

The facial image registration apparatus, according to an embodiment of the present invention, includes a controller 100, a key input unit 110, a camera unit 120, a face detector 130, a face feature value calculator 140, and a memory unit 150.

The controller 100 controls the general operation of the facial image registration apparatus. The controller 100 also stores a plurality of images captured by the camera unit 120 in the memory unit 150 upon input of a key for face registration through the key input unit 110.

The controller 100 then checks if a facial image is detected from a first captured image among the plurality of stored images by the face detector 130. If a facial image has not been detected from the first captured image, the controller 100 may display a message requesting face registration on a screen.

However, if a facial image has been detected from the first captured image, the controller 100 detects a facial image from each of the stored plurality of captured images by using the face detector 130. The controller 100 detects a facial image by performing a face tracking function with the facial image detected from the first captured image to speed up face detection. The face tracking function, which is a sort of motion tracking that tracks motion of an object, allows face detection to be completed faster than face detection using face recognition.

The controller 100 calculates a face feature value for each of a plurality of detected facial images through the face feature value calculator 140. A face feature value is a score applied according to face features in a facial image, such as an image blur degree, eye blink, facial expression, and so on. For example, if scores 0 to 5 are applied according to an eye closed rate, the face feature value calculator 140 applies a score 0 if the eyes are completely closed, a score 3 if the eyes are half closed, and a score 5 if the eyes are completely open.

The controller 100 sorts the plurality of facial images according to the calculated feature point values. The controller 100 may sort the plurality of facial images in an order from a facial image having a large face feature value to a facial image having a small face feature value.

The controller 100 generates a plurality of face feature images having different image features for each of the plurality of sorted facial images. The image features include resolution, exposure, brightness, etc. For example, the controller 100 may generate five face feature images having sizes of 160 pixels×120 pixels, 320 pixels×240 pixels, 720 pixels×480 pixels, 1024 pixels×680 pixels, and 1280×720 pixels, respectively, for the original facial image having a size of 640 pixels×360 pixels.

If the controller 100 generates face feature images having M sizes for each of N captured images, a total number of generated face feature images is N×M. Herein, N and M are natural numbers.

The controller 100 performs a face recognition algorithm on each of the generated face feature images and calculates a face feature value from each of the face feature images on which the face recognition algorithm is performed to detect a reference facial image having the largest face feature value.

The controller 100 calculates a difference between the face feature value of the detected reference facial image and the face feature value of each of the face feature images, and sorts the face feature images in an order from a face feature image having the smallest difference to a face feature images having the largest difference.

The controller 100 selects K facial images at random from the sorted face feature images to store them as target facial images to be used for face recognition. Herein, K is a natural number.

The key input unit 110 includes an image capturing key for face recognition, and forwards data of a key value corresponding to a key pressed by a user to the controller 100.

The camera unit 120 converts a light signal input by the input of the image capturing key into an image and outputs the image.

The face detector 130 sets the first captured image among the plurality of captured images as a reference image and detects a facial image from the set reference image. The face detector 130 performs the face tracking function by using the detected facial image, thereby detecting a facial image from each of the plurality of captured images.

The face feature value calculator 140 calculates a face feature value for each of the plurality of detected facial images. The face feature value calculator 140 also calculates a face feature value for each of a plurality of facial images having different image features.

The memory unit 150 stores an image captured by the camera unit 120 and stores K images selected at random from a plurality of facial images.

Thus, the present invention can register facial images having various face feature values used for face recognition by user manipulation.

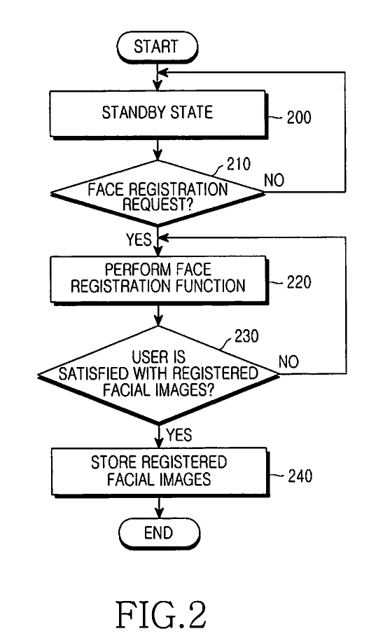

FIG. 2 is a flowchart illustrating a process for registering target facial images to be used for face recognition and performing face recognition by using the registered target facial images, according to an embodiment of the present invention.

Referring to FIG. 2, the controller 100 is in a standby mode in step 200, and determines whether a face registration request is input through the key input unit 110 in step 210. If the face registration request is input, the controller 100 goes to step 220; otherwise, the controller 100 goes back to step 200 to maintain the standby mode.

In step 220, the controller 100 performs a facial image registration operation of detecting a facial image from each of a plurality of original images input from the camera unit 120. Image conversion is performed on the detected facial images according to a plurality of image features, and a random number of facial images is registered, thereby registering target facial images to be used for face recognition.

In step 230, the controller 100 checks if a user is satisfied with the registered target facial images. If the user is satisfied, the controller 100 goes to step 240; otherwise, the controller goes back to step 220 to perform the facial image registration operation again. The controller 100 displays a popup window for checking if the user is satisfied with the registered target facial images on a screen, and if there is an input indicating the user's satisfaction from the key input unit 110, the controller 100 goes to step 240; otherwise, the controller 100 goes back to step 220.

In step 240, the controller 100 stores a plurality of target facial images generated during the facial image registration operation in the memory unit 150, thus completing the facial image registration operation.

In this way, the present invention can improve a face recognition rate by registering a plurality of target facial images through a user's single key input.

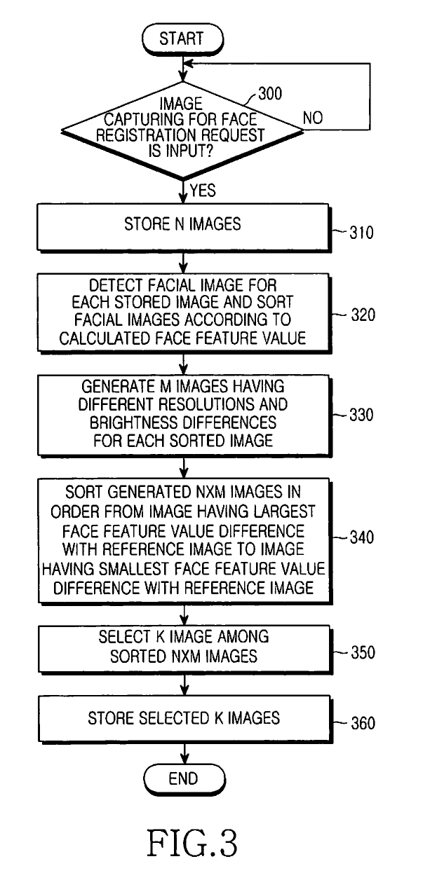

FIG. 3 is a flowchart illustrating a facial image registration method for registering a plurality of target facial images to be used for face recognition, according to an embodiment of the present invention.

In step 300, the controller 100 checks if an image capturing request for facial image registration is input. If the image capturing request is input, the controller 100 goes to step 310; otherwise, the controller 100 checks again if the image capturing request is input in step 300.

In step 310, the controller 100 stores a plurality of captured images input from the camera unit 120 in the memory unit 150. The controller 100 controls the camera unit 120 to capture N images upon the input of the image capturing request for facial image registration.

In step 320, the controller 100 detects a facial image from each of the stored plurality of captured images through the face detector 130, and sorts a plurality of detected facial images according to a face feature value calculated for each of the detected facial images by the face feature value calculator 140. The face feature value is a score applied according to face features, such as an image blur degree, eye blink, facial expression, and so on, and may be arbitrarily set by the user or may be preset in an apparatus.

In step 330, the controller 100 generates face feature images having different resolutions and different brightness differences for each of the plurality of sorted facial images. For example, the controller 100 may generate N×M×P face feature images having P different brightness differences for N facial images having M different resolutions. Herein, P is a natural number.

In step 340, the controller 100 calculates a face feature value for each of the plurality of generated face feature images through the face feature value calculator 140, and sorts the plurality of generated face feature images in an order from a face feature image having the smallest face feature value difference with a reference facial image to a face feature image having the largest face feature value difference with the reference facial image. A face feature image having the largest face feature value and the highest resolution may be set as the reference facial image, or may be set arbitrarily by the user.

In step 350, the controller 100 selects K target facial images to be used for face recognition among the plurality of sorted face feature images. Herein, K is a natural number, and may be set arbitrarily by the user or may be preset by default.

In step 360, the controller 100 stores the selected K target facial images in the memory unit 150 to register a plurality of user's facial images, thus completing the facial image registration operation.

As is apparent from the foregoing description, by registering a plurality of various facial images at a user's single request during a face registration process necessary for face recognition, the user can conveniently register a plurality of facial images at a time and a face recognition rate can be improved by using the plurality of registered facial images during face recognition.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A facial image registration apparatus for registering a plurality of facial images for face recognition, the facial image registration apparatus comprising:
a camera unit for capturing and outputting a plurality of images;
a face detector for detecting a plurality of facial images from the plurality of captured images, respectively;
a face feature value calculator for calculating a face feature value for each of the plurality of facial images, wherein the face feature value is a score that is applied according to face features of each of the plurality of facial images; and
a controller for detecting and sorting the plurality of facial images at a request of a user through the face detector, calculating face feature values for the plurality of sorted facial images through the face feature value calculator, and registering target facial images to be used for face recognition, which are selected according to the calculated face feature values.

2. The facial image registration apparatus of claim 1, wherein the controller applies a score to each of the plurality of facial images and sorts the plurality of facial images in an order from a facial image having a highest score to a facial image having a lowest score.

3. The facial image registration apparatus of claim 2, wherein the controller sorts the plurality of facial images in an order from a facial image having a largest face feature value to a facial image having a smallest face feature value, and generates a plurality of face feature images having a plurality of different image features for each of the plurality of sorted facial images.

4. The facial image registration apparatus of claim 3, wherein the controller sorts the plurality of face feature images in an order from a face feature image having a largest face feature value difference from a predetermined reference face feature image among the plurality of face feature images, to a face feature image having a smallest face feature value difference from the predetermined reference face feature image, and selects a predetermined number of face feature images from the plurality of sorted face feature images.

5. The facial image registration apparatus of claim 4, wherein the image features comprise at least one of a resolution of an image and a brightness of an image.

6. A facial image registration method for registering a plurality of facial images to be used for face recognition, the facial image registration method comprising the steps of:
detecting and sorting a plurality of facial images from a plurality of images input from a camera unit at a request of a user;
calculating a face feature value for each of the plurality of facial images, wherein the face feature value is a score that is applied according to face features of each of the plurality of facial images; and
registering target facial images to be used for face recognition, which are selected according to the calculated face feature values.

7. The facial image registration method of claim 6, wherein sorting the plurality of facial images comprises:
applying a score to each of the plurality of facial images; and
sorting the plurality of facial images in an order from a facial image having a highest score to a facial image having a lowest score.

8. The facial image registration method of claim 6, wherein registering the selected target facial images comprises:
sorting the plurality of facial images in an order from a facial image having a largest face feature value to a facial image having a smallest face feature value;
generating a plurality of face feature images having a plurality of different image features for each of the plurality of sorted facial images;
sorting the plurality of face feature images in an order from a face feature image having a largest face feature value difference from a predetermined reference face feature image among the plurality of face feature images, to a face feature image having a smallest face feature value difference from the predetermined reference face feature image; and
selecting a predetermined number of face feature images from the plurality of sorted face feature images.

9. The facial image registration method of claim 8, wherein the image features comprise at least one of a resolution of an image and a brightness of an image.
